(19) United States
(12) Patent Application Publication
(10) Pub. No.: US 2022/0282660 A1
(43) Pub. Date: Sep. 8, 2022

(54) CONTROLLABLE COOLANT PUMP WITH PISTON ROD GUIDE

(71) Applicant: NIDEC GPM GmbH, Auengrund OT Merbelsrod (DE)

(72) Inventors: Daniel DÖHLER, Nahetal-Waldau (DE); Stephan STEINKE, Ilmenau / OT Manebach (DE); Robert BOCK, Ilmenau (DE)

(21) Appl. No.: 17/637,149

(22) PCT Filed: Aug. 21, 2020
(86) PCT No.: PCT/EP2020/073518

§ 371 Date: Feb. 22, 2022

(30) Foreign Application Priority Data
Aug. 23, 2019 (DE) 10 2019 122 717.8

(51) Int. Cl. F01P 5/12; F01P 7/14; F04D 15/00

(52) U.S. Cl. CPC F01P 5/12; F01P 7/14; F04D 15/0038; F01P 2007/146

(57) ABSTRACT

A controllable coolant pump of internal combustion engines includes a pump housing, a drivable pump shaft rotatably mounted in the pump housing, an impeller non-rotatably fixed on a free end of the pump shaft, and a pressure-difference-driven actuator to drive at least one piston rod which is guided in a piston rod bore of the pump housing and includes a control spool valve held at the impeller-side end of the piston rod. The control spool valve is set up to variably cover an outflow region of the impeller. The piston rod is guided in the piston rod bore by a guide bushing which is a portion of a sealing device which seals off a pump chamber carrying the coolant with respect to the pressure-difference-driven actuator.

### CROSS REFERENCE TO RELATED APPLICATIONS

This is a U.S. national stage of PCT Application No. PCT/EP2020/073518, filed on Aug. 21, 2020, and with priority under 35 U.S.C. § 119(a) and 35 U.S.C. § 365(b) being claimed from German Application No. 10 2019 122 717.8, filed Aug. 23, 2019, the entire disclosures of which are hereby incorporated herein by reference.

### 1. FIELD OF THE INVENTION

The present disclosure relates to a controllable coolant pump of internal combustion engines.

### 2. BACKGROUND

Controllable coolant pumps have a control system for varying the cooling capacity. Such a control system is described in, for example, DE 10 2005 062 200 B3. A valve spool has an outer cylinder which variably covers the discharge area of the impeller of the coolant pump. The valve spool is arranged on several piston rods which are movably mounted in the pump housing. The position of the valve spool reflects the coolant flow and thus the cooling capacity. The piston rods are guided in a sealed piston guide in the pump housing. To prevent the piston rod from jamming in the guide, a generous clearance fit in the guide is necessary. The clearance in the guide, as well as radial forces that occur, lead to a deflection of the piston rod during operation, whereby the contact between the piston rod and the guide represents the pivot point of the piston rod. The occurring tilting of the piston rod is compensated for by the piston rod seals, so that sealing of the controllable coolant pump can be ensured. It has been found that with the running time of the coolant pumps, the seals can no longer withstand the loads and they can no longer provide the compensating capacity in the case of tilting, so that leaks occur.

### SUMMARY

Example embodiments of the present disclosure provided controllable coolant pumps each including a piston rod guide that is reliably sealed over a long running time.

An example embodiment of the present disclosure provides a controllable coolant pump of internal combustion engines including a pump housing, a drivable pump shaft rotatably mounted in the pump housing, an impeller fixed on a free end of the pump shaft, and a pressure-difference-driven actuator to drive at least one piston rod guided in a piston rod bore of the pump housing, which includes a control spool valve held at the impeller-side end of the piston rod, the control spool valve being set up to variably cover an outflow region of the impeller, and the piston rod being guided in the piston rod bore by a guide bushing which is a portion of a sealing device that seals off a pump space carrying the coolant with respect to the pressure-difference-driven actuator. The piston rod bore includes a region which is spaced apart from the guide bushing, is located on the side of the guide bushing remote from the control valve and in which the clear width of the piston rod bore is smaller than in the remaining portion of the piston rod bore to define a second guide of the piston rod.

Because the piston rod includes two spaced guide points or areas, tilting of the piston rod in the bore can be limited, thus reducing or minimizing stress on the sealing device and resulting in longer seal life. The piston rod can also be easily inserted into the bore. It rests exclusively in the two guides on the inside of the bore.

The second guide is as far away from the guide bushing as possible to reduce or minimize tilting of the piston rod and thus radial deflection of the rod. It is advantageous if the axial distance between the guide bushing and the second guide is at least half the axial length of the sealing device.

Preferably, the second guide has a clear width which corresponds with clearance to the outside diameter of the piston rod. The circumferential clearance is preferably at least about 0.01 mm, for example.

To prevent jamming, the second guide or the taper of the piston rod bore that defines the second guide preferably includes a short cylindrical region that preferably extends in the axial direction over a fraction of the length of the piston rod. The taper is thus provided cylindrically over only a small portion of the entire length in the axial direction. It is advantageous if the guide is linear. The first guide defined by the guide bushing also preferably includes a short supporting portion to prevent jamming of the piston rod.

It is advantageous if the piston rod bore includes a shoulder which reduces the passage opening and lies between the sealing device and the second guide in the axial direction in the assembled state of the arrangement. The sealing device preferably is in contact with this shoulder. The shoulder defines and functions as an axial support for the sealing device.

In one example embodiment, a piston slide is held on the piston rod at its end remote from the control spool in a vacuum chamber in a piston slide receptacle in a rolling diaphragm, the vacuum chamber being connected to the piston rod bore by a through hole of reduced internal diameter, the through hole defining the second guide.

It is advantageous if the piston rod can be moved parallel to the pump shaft by the pressure differential driven actuator.

The pressure differential actuator is preferably a pneumatic actuator. In an example embodiment, a negative pressure chamber is sealed by, among other things, a rolling diaphragm. When the negative pressure chamber is then evacuated, the diaphragm rolls out due to the pressure difference between the atmospheric pressure and the negative pressure area, thus moving the piston slide in which the piston rods are suspended.

Preferably, the guide bushing is made of a thermoplastic material. The sealing device preferably includes elastomer seals. It is advantageous if the elastomer seals and the guide bushing are combined in a materially bonded or form-fitted manner to define one component, which results in the advantage of loss resistance. Preferably, a seal is provided on each side of the guide bushing in the axial direction.

Preferably, the sealing device includes two sealing elements spaced apart from one another, each of which is on one end of the guide bushing and each of which includes a static sealing region surrounding the guide bushing on the circumferential side and a dynamic sealing region adjoining the static sealing region, a first seal to seal a pressure chamber of the differential pressure-driven actuator at the end of the guide bushing remote from the impeller and a second seal to seal the pump chamber carrying coolant at the end of the guide bushing near the impeller. The dynamic sealing region of the first sealing element extends into the interior of the guide bushing from the end surface at the end remote from the impeller and is tapered inward into the guide bushing in the axial direction. The dynamic sealing region thus provides a reliable seal of the pressure chamber. In the event that coolant enters the space between the sealing elements, the structure ensures that the first sealing element does not lift off the piston rod but remains close to it, thus always providing a secure seal.

Preferably, the dynamic sealing region of the first sealing element is spaced from the inside of the guide bushing in the unloaded state.

If the piston rod tilts in the bore, the dynamic area of the first sealing element follows the movement without losing the radial circumferential contact, in particular line contact, with the piston rod. The structure of the first sealing element ensures that a reliable seal is maintained even if the piston rod tilts.

It is also advantageous if the sealing lip of the second sealing element is elastically preloaded towards the piston rod by an overlap of the dynamic sealing region.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure are explained in more detail below with reference to the drawings. Similar or similarly acting components are designated in the figures with the same reference signs.

FIG. 1 shows a longitudinal section through a controllable coolant pump with piston rod guide according to an example embodiment of present disclosure.

FIG. 2 shows a detailed view of the piston rod guide.

FIG. 3 shows a detailed view of a sealing device of a piston rod guide according to an example embodiment of present disclosure in longitudinal section.

FIG. 4 shows an enlarged view of a guide bushing of the sealing device of FIG. 3 in longitudinal section and in spatial representation.

FIG. 5 shows an enlarged view of a first sealing element of the sealing device of FIG. 3 in longitudinal section.

FIG. 6 shows an enlarged view of a second sealing element of the sealing device of FIG. 3 in longitudinal section.

### DETAILED DESCRIPTION

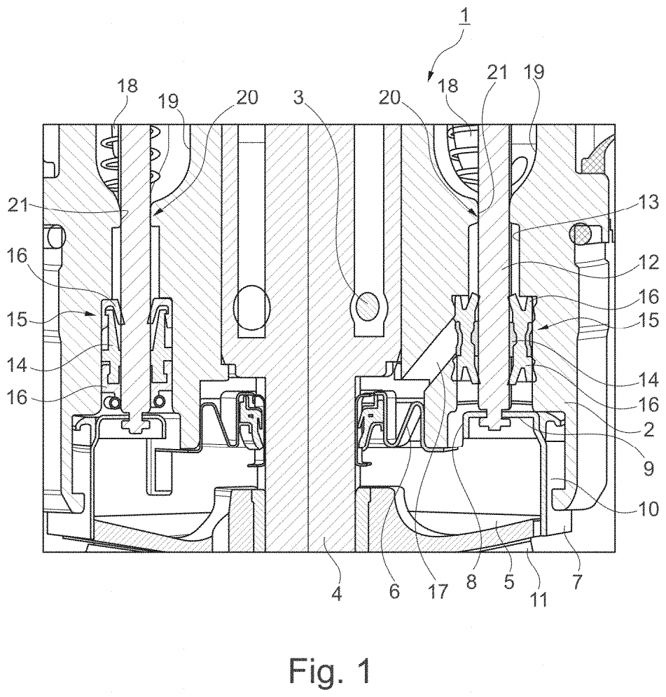

FIG. 1 shows a controllable coolant pump 1 with a pump housing 2. The pump shaft 4, which is driven by a drive wheel not shown, is rotatably mounted in the pump housing 2 in a pump bearing 3. An impeller 5 is seated non-rotatably on the free, flow-side end of the pump shaft 4. The pump shaft 4 is surrounded by a mechanical seal 6 between the pump bearing 3 and the impeller 5. A pressure-actuated control spool 7 is arranged in the pump interior. The control spool 7 is pot-shaped with a central opening 8. It concentrically surrounds the pump shaft 4. It has an annular base 9 and a peripheral surface 10 surrounding the base 9. Depending on the position of the control spool 7, the outer surface 10 covers the discharge area 11 of the impeller 5. In the area of the base 9, the control spool 7 is firmly connected to guide rods 12. In an example embodiment, three guide rods 12 are provided. The guide rods 12 extend parallel to the pump shaft 4 and are evenly distributed over its circumference. The guide rods 12 are piston rods which are axially guided in piston rod bores 13 in the pump housing 2.

The piston rods 12 are driven by a pressure differential driven actuator, in this case a pneumatic actuator operating with vacuum. The piston rod 12 is guided on the control valve side in a guide bushing 14 in the piston rod bore 13. The guide bushing 14 is part of a sealing device 15, each with two sealing elements 16. The two sealing elements 16 are each arranged at one end of the guide bushing 14. They are spatially separated from each other and do not influence each other. The sealing element far from the impeller seals the vacuum chamber of the pneumatic drive and the sealing element near the impeller seals the pump chamber carrying coolant.

A drainage outlet 17 arranged between the two sealing elements 16 can discharge a coolant that has penetrated into the space between the two sealing elements 16.

The piston rod 12 is held on the vacuum side in a piston slide 18. The piston slide 18 is arranged in a piston slide holder in a rolling diaphragm in a vacuum chamber 19 whose inner diameter is larger than that of the piston rod bore 13. The piston slide receptacles are thus connected to each other via the continuous rolling diaphragm. The vacuum chamber is sealed by the rolling diaphragm, which also receives the piston slide. The vacuum area is sealed by axial compression of the rolling diaphragm in the housing and the seal 16 in contact with the piston rod. This area is connected to the vehicle's vacuum supply by a hose nozzle pressed into the housing. When the vacuum chamber is evacuated, the diaphragm rolls out due to the pressure difference between the atmospheric pressure and the vacuum area, thus moving the piston slide in which the piston rods are suspended. By the pneumatic actuator, the control spool 7 can be moved between an open position and a closed position.

In the open position shown in FIG. 1, the outflow area 11 of the impeller 5 is free and not covered by the control spool 7. In the closed position, however, the control spool completely covers the outflow area.

The guide bushing 14 is preferably injection molded from a thermoplastic. For demolding the finished plastic part from the injection mold, a demolding bevel (also called a lift-out bevel) is preferably provided in the inner diameter, which results in the piston rod being guided only at the smallest diameter of the guide bushing.

In order to reduce tilting of the piston rod 12 in the pump housing 2 and a load on the sealing device 15, a second guide 20 of the piston rod 12 in the pump housing 2 is provided. The second guide is spaced from the sealing device in the axial direction by approximately the axial length of the latter, preferably at least by half the axial length of the sealing device. The distance should be chosen as large as possible. The second guide point 20 is formed by a through hole 21 between the vacuum chamber 19 and the piston rod bore 13. The through hole 21 has a clear width that is smaller than the clear width of the vacuum chamber 19 and piston rod bore 13. The clear width of the through hole 21 is matched with some clearance to the outer diameter of the piston rod 12. The cylindrical portion of the through hole 21 is to be designed as small as possible so that the risk of jamming of the guide rod 12 in the through hole 21 is minimized. The piston rod 12 is thus guided only on the vacuum side on the pump housing 2 and in the area of the sealing device 15 by a guide bushing 15 in the pump housing 2. Due to the “two-point guide”, tilting of the piston rod 12 is only possible to a limited extent even when force is applied to the piston rod 12. The sealing device 15 will age over the life of the pump, which reduces its compensating capacity in the event of piston rod deflection. The two-point guide reduces the radial deflection of the piston rod so that the compensating capacity of the sealing device 15 does not have to be as high.

The sealing elements 16, in particular elastomer seals, are preferably positively connected to the guide bushing 15. It may also be provided that the guide bushing 15 is injection-molded around or through with a material or that the material is vulcanized onto the outside of the guide bushing 15 to form the sealing elements 16. The sealing elements 16 are preferably sealing lips. The piston rod bore has a shoulder reducing the passage opening, which is located in the axial direction in the assembled state of the arrangement between the sealing device 15 and the second guide point 20. The sealing device 15 lies in contact with this shoulder. The shoulder serves as an axial support for the sealing device 15.

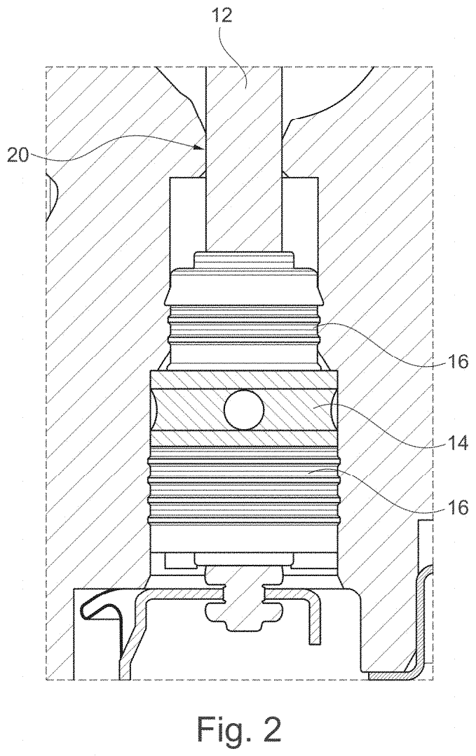

FIG. 2 shows a detailed view of two guides 20,14 of the piston rod 12. The two sealing elements 16 have a profiling on their outer sides with which they can be brought into contact with the inner side of the piston rod bore for sealing.

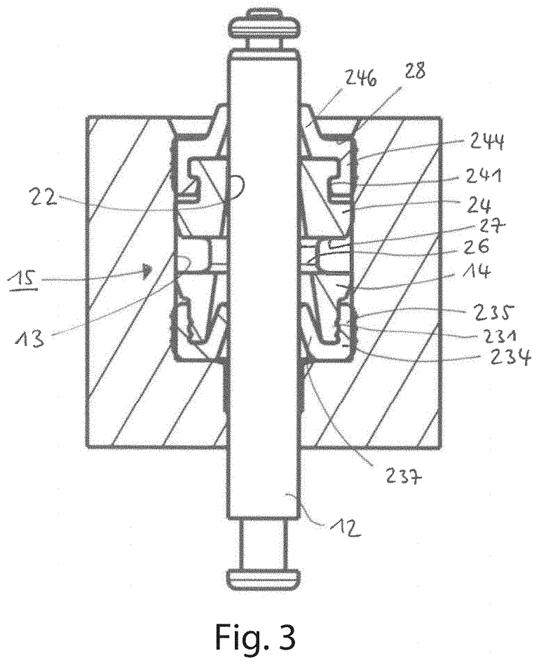

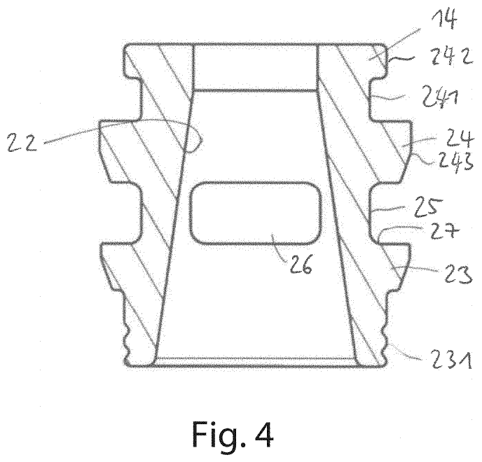

FIGS. 3 to 6 show in detail a preferred sealing device 15 with guide bushing 14. The guide bushing 14 has an aperture 22 passing through it, which has a continuously increasing inner diameter. In the assembled state, the opening 22 is penetrated by the piston rod 12. In the area of the smallest inner diameter, the piston rod 12 is guided in the guide bushing 14. The guide bushing 14 is preferably injection molded from a thermoplastic. For demolding the finished plastic part from the injection mold, a demolding bevel (also called a lift-out bevel) is preferably provided in the inner diameter, which results in the piston rod 12 being guided only at the smallest diameter of the guide bushing 14.

The guide bushing 14 has two sections 23,24, each of which is designed to receive a sealing element 16. The two sections 23,24 are connected to each other by a central area 25, which is penetrated by at least one radial opening 26. The outer diameter of the guide bushing 14 in this central region 25 is significantly smaller than the inner diameter of the piston rod bore 13, so that a peripheral recess 27 is formed on the outside of the guide bushing 14. The radial openings 26 form an inner drainage outlet and the circumferential recess 27 an outer drainage outlet. A coolant that has entered the guide bushing 14 can be drained radially outwardly into the recess 27 through the radial openings and discharged outwardly through the drainage. Due to the circumferential recess 27, it is not necessary to pay attention to a positionally accurate installation position of the sealing device 15. In the axial direction, however, care must be taken to ensure exact positioning in order to form the leakage system with the circumferential recess 27 of the guide bushing 14 and the leakage drainage holes in the pump housing 2, otherwise the areas 23 and 24 will close off the leakage system of the pump.

The section 23 of the guide bush 14 close to the impeller has a circumferential groove 241, each of which is bounded in the axial direction by two annular webs 242,243. The inner web 243 has an outer diameter which produces the interference fit in the housing by overlapping with the piston rod bore 13.

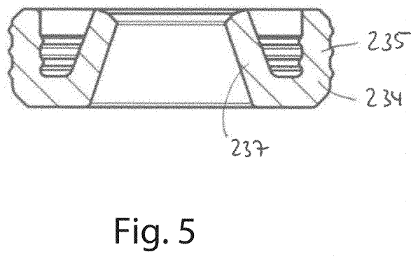

A pneumatic sealing element 234 is accommodated at the axial end 231 of the section remote from the impeller for sealing with respect to the pressure differential-controlled actuator or the vacuum chamber. The sealing element 234 shown in detail in FIG. 5 has a static sealing region 235 which surrounds the guide bushing 14 circumferentially with the inner side and which is seated on the outer side of the guide bushing at the end 231. The outer side of this static sealing region 235 abuts the inner side of the piston rod bore 13. The static sealing region 235 surrounds the end surface of the end 231 of the guide bushing 14 remote from the impeller and thus completely covers it. The end surface formed in the installed position of the sealing device by the pneumatic sealing element 234 is in contact with a shoulder 28 of the piston rod bore 13 in the assembled state, which is formed by the narrowing to form the through hole 21. The radial overlap of the outer diameter of the pneumatic sealing element 234 with the piston rod bore ensures a static seal. It may also be provided that the pneumatic sealing element 234 has on the end surface a circumferential bead, not shown, which is axially compressed during assembly.

The static sealing section 235 of the pneumatic sealing element 234 merges into a dynamic sealing section 237, which is formed as a sealing lip. The sealing lip 237 extends inwardly into the guide bushing 14 in the axial direction, protruding inwardly from the inside of the guide bushing 14 in the radial direction, and is tapered inside the guide bushing 14 in the direction of the pump chamber while maintaining the same wall thickness. In other words, the taper is present on the inner side and the outer side of the sealing lip 237. When the piston rod 12 is mounted, the dynamic sealing section 237 is in sealing contact with the outside of the piston rod 12 under radial preload. The dynamic sealing section 237 is dimensioned in such a way that at least one third, in particular more than 40%, of the height, defined in the axial direction, of the section 23 of the guide bushing 14 remote from the impeller wheel and extending from the leakage groove 25 is covered in the interior.

On the side of the sealing device 15 facing the actuator, vacuum prevails in the pump housing 2. In contrast, atmospheric pressure prevails between the sealing elements 23,24. Due to the pressure difference, the sealing lip 237 nestles against the piston rod 12 on its inner side. In the event that cooling liquid enters the space between the sealing elements 23,24 and the pressure on the dynamic sealing section 237 increases from the inside, the dynamic sealing section 237 is pressed against the piston rod 12 and the tightness is increased. It is thus possible to prevent the pneumatic sealing member 234 from leaking due to load.

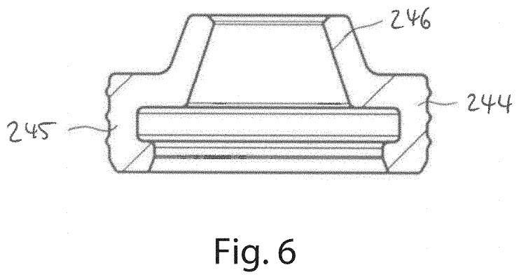

A hydraulic sealing element 244 is received in the groove 241 of the section 24 of the sealing device 15 near the impeller for sealing against the pump chamber. The sealing element 244 shown in detail in FIG. 6 has a static sealing region 245 which surrounds the guide bushing 14 on the circumferential side and which engages in the annular groove 241. The outside of the static sealing region 245 abuts the inside of the piston rod bore 13. The static sealing region 245 at least partially surrounds the end surface of the guide bushing near the impeller and merges into a dynamic sealing region 246, which projects outwardly in the axial direction beyond the guide bushing 245. The dynamic sealing region 246 extends inward in the radial direction and is formed as a sealing lip. The sealing lip 247 extends from the end surface of the guide bushing 14 near the impeller into the pump chamber. The sealing lip 247 is conical and tapers away from the guide bushing 14. Its end near the impeller therefore fits tightly against the piston rod 12. The inner diameter of the sealing lip 247 in this area is selected so that the hydraulic sealing element 244 is securely in contact with the piston rod 12. The pump medium pressure on the hydraulic sealing element 244 presses the sealing lip 247 against the piston rod 12.

In conjunction with the two-point guide, the sealing device has the advantage that the load on the sealing device can be limited and that any tilting of the piston rod that nevertheless occurs can be compensated for by the sealing device without losing sealing contact with the piston rod. Since the loads are minimized, the service life of the sealing device is significantly increased.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-7. (canceled)

8: A controllable coolant pump of internal combustion engines, the controllable coolant pump comprising:
a pump housing;
a drivable pump shaft rotatably mounted in the pump housing;
an impeller non-rotatably fixed on a free end of the pump shaft; and
a pressure-difference-driven actuator to drive at least one piston rod which is guided in a piston rod bore of the pump housing and includes a control spool valve held at an impeller-side end of the piston rod, the control spool valve being set up to variably cover an outflow region of the impeller; wherein
the piston rod is guided in the piston rod bore by a guide bushing which is a portion of a sealing device which seals off a pump chamber carrying the coolant with respect to the pressure-difference-driven actuator; and
the piston rod bore includes a region which is spaced apart from the guide bushing, is located on a side of the guide bushing remote from the control valve, and in which a clear width of the piston rod bore is smaller than in remaining portions of the piston rod bore in order to define a second guide of the piston rods in the piston rod bore.

9: The controllable coolant pump according to claim 8, wherein the second guide includes a clear width which corresponds with a clearance to an outer diameter of the piston rod.

10: The controllable coolant pump according to claim 8, wherein the second guide includes a small cylindrical portion which extends in an axial direction over a fraction of an outer diameter of the piston rod.

11: The controllable coolant pump according to claim 8, wherein
a piston slide is held on the piston rod at an end remote from the control spool valve in a vacuum space, which is in a piston slide receptacle in a rolling diaphragm, the vacuum space being connected to the piston rod bore by a through hole which includes a reducing internal diameter, the through hole defining the second guide.

12: The controllable coolant pump according to claim 8, wherein the piston rod is movable parallel to the pump shaft by the pressure-difference-driven actuator.

13: The controllable coolant pump according to claim 8, wherein the guide bushing is made of a thermoplastic material, and the sealing device includes elastomeric seals.

14: The controllable coolant pump according to claim 13, wherein the elastomer seals and the guide bushing are combined into one component in a material-locking or form-fitting manner.
